(19) United States
(12) Patent Application Publication
(10) Pub. No.: US 2007/0271363 A1
(43) Pub. Date: Nov. 22, 2007

(54) Computer compliance system and method

(76) Inventors: Kevin Ross, Newtown, CT (US); Jason Grazado, Scarsdale, NY (US)

Correspondence Address: BUCKLEY, MASCHOFF & TALWALKAR LLC, 50 LOCUST AVENUE, NEW CANAAN, CT, 06840, US

(21) Appl. No.: 11/437,223

(22) Filed: May 19, 2006

(51) Int. Cl. G06F 15/173

(52) U.S. Cl. 709/223

(57) ABSTRACT

According to some embodiments, a system and a method is provided to dynamically scan a network with a first network scanner and a second network scanner and to determine a new network address, wherein the new network address is discovered by the first network scanner and not discovered by the second network scanner.

### BACKGROUND

A computer network may connect many devices such as desktop computers, printers, web servers, routers, databases, and laptops. In a large networked environment these devices are routinely being connected and disconnected. In such an environment it is difficult to accurately know what software may be loaded on each device and what devices are connected to the network at any given moment.

A large networked environment may create a risk of having networked devices connected without the knowledge or permission of network managers. Unauthorized networked devices may contain viruses, lack proper virus protection, or may be used for unauthorized capture of network traffic. A need has arisen for network managers to be updated about unauthorized networked devices within the shortest amount of time and what software may be loaded on each network device. Network Managers must ensure that computers are configured properly and loaded with software that protect against security compromises.

### BRIEF DESCRIPTION OF THE DRAWINGS

FIG. 1 is a diagram of a system according to some embodiments.

FIG. 2 is a block diagram of a method according to some embodiments.

FIG. 3 is a block diagram of a method according to some embodiments.

FIG. 4 is a diagram of a display according to some embodiments.

FIG. 5 is a block diagram of a method according to some embodiments.

FIG. 6 is a database table according to some embodiments.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

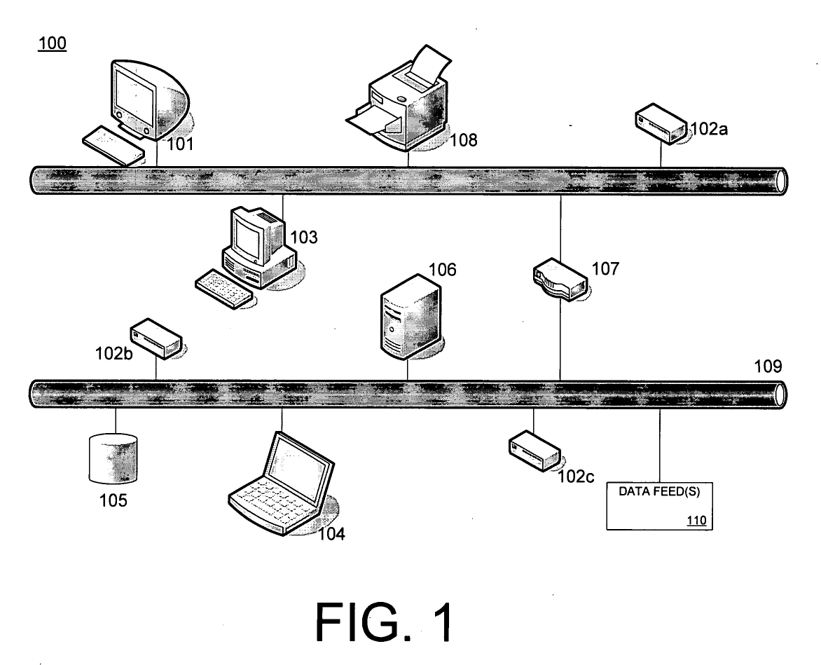

Referring now to FIG. 1, an embodiment of a system 100 is shown. A network 109 may have one or more segments. A network segment may be a portion of a computer network separated by a computer-networking device such as, but not limited to, a repeater, an Ethernet hub, a bridge, a switch, and a router. In some embodiments, the network may consist of at least one of a metropolitan area network (“MAN”), a wide area network (“WAN”), a local area network (“LAN”), and a virtual private network (“VPN”). The network may be any available network. A first network segment may be connected to a second network segment by a router 107 and attached to each segment may be a plurality of different devices such as, but not limited to, a terminal 101, a printer 108, a desktop computer 103, a server 106, and a database 105.

The network 109 may also connect one or more network scanners 102a/102b/102c. The network scanners 102a/102b/102c may be, but are not limited to, device enumerators and/or network device probes. A device enumerator may scan each network address on a network subnet. A network device probe may scan known network devices stored in a database 105. The known network devices may be associated with a time stamp. In one embodiment, the network device probe may first scan known network devices associated with an earlier time stamp and then scan network devices associated with a later time stamp.

FIG. 1 illustrates three network scanners. However, a network 109 may contain any number of network scanners. Each network scanner 102a/102b/102c is connected to a segment of the network 109 and may attempt to discover every network device connected to that network. In some embodiments, each network scanner 102a/102b/102c may attempt to discover every network device on every segment of the network by dynamically scanning the network. Each network scanner 102a/102b/102c may utilize an Internet control message protocol (“ICMP”) ping to discover each network device. However, in other embodiments each network scanner 102a/102b/102c may utilize any available protocol to discover new network addresses. A network address may be, but is not limited to, an Internet Protocol (“IP”) address, a Medium Access Control (“MAC”) address, and a machine name. The network scanners 102a/102b/102c may repeat dynamic scanning after a predetermined period of time or after all previously known devices have been scanned. In some embodiments, the network scanners 102a/102b/102c may continuously dynamically scan the network.

In some embodiments, an unknown device 104 may be periodically connected and disconnected from the network 109. The unknown device 104 may be any networkable device such as, but not limited to, a laptop computer, a desktop computer, a server, a wireless access point, a hub, and a switch. For example, the unknown device 104 may belong to a user who has previously connected the unknown device 104 to an external network. As another example, the unknown device 104 may be attached to a network for illegal or illicit purposes such as for the unauthorized capture of data.

For illustrative purposes, and to aid in understanding features of the invention, an example will now be introduced. This example will be carried through the detailed description and this example is not intended to limit the scope of the invention.

A large organization has a large multi-segmented network. A salesman arrives to give a demonstration of a new product and proceeds to connect his laptop computer to the network to gain access to his email. The salesman has performed many demonstrations of his product and his laptop computer has been previously attached to other networks. It is not known if his laptop computer has a virus that may spread across the network, if the salesman's laptop computer has adequate virus protection, or if the salesman may receive an email containing a virus.

A database 105 may store network addresses and related data provided by the network scanners 102a/102b/102c. Each network scanner 102a/102b/102c may access the database 105 to determine what network addresses are known. In one embodiment, a first network scanner 102a may dynamically scan to discover a new network address associated with the unknown device 104 that was not previously known to the first network scanner. The first network scanner 102a may send this new network address to the database 105. The database 105 may insert the new network address so that a second network scanner 102b and a third network scanner 102c may be informed of the new network address. In a preferred embodiment, the database 105 may contain a master machine table and a master subnet table. The master machine table may contain a list of every network device organized by a machine name of each device. In some embodiments, the master machine table may be organized by machine name by an IP address or by a MAC address. The master machine table may contain a time stamp associated with each network device that indicates the last time a network device was scanned. The master subnet table may contain a list of known subnets. Each network scanner 102a/102b/102c may access the database 105 to determine which device and subnet to scan. In one embodiment, if the new network address of the unknown device 104 is on a subnet that was not previously known, the new subnet will be scanned. In another embodiment, each network scanner 102a/102b/102c may contain a list of known addresses and share known addresses with other network scanners 102a/102b/102c. The database 105 may set a flag that indicates when a device has not been scanned, reported by a data feed, or discovered by a login script within a predetermined period of time. The flag may instruct each network scanner 102a/102b/102c to stop scanning a flagged device. The network scanners 102a/102b/102c may scan each network device based on its associated time stamp. In one embodiment, the new network address of the unknown device 104 may be determined by combining data from the data feeds and the network scanners.

The database 105 may receive data from a plurality of data feeds 110. Some examples of a data feed 110 may be, but are not limited to, a login script, a central anti-virus control system, and a firewall system. The plurality of data feeds 110 may send data about known devices to the database 105.

The server 106 may contain a processor. The processor may execute instructions stored in a medium. The server 106 may function as a web server and/or a database server. A database entry created by a data feed 110 or a scanner 102a/102b/102c may contain information known by that data feed 110 or scanner 102a/102b/102c thereby leaving certain database fields blank or null. For example, the server 106 may determine that a scanner 102a reports on 100 known devices and an anti-virus central control system reports on 50 known devices. The server 106 may send a notification to support personnel such as, but not limited to, a help desk and a desktop support group to inform the support personnel that 50 devices are not registered with the anti-virus control system. The notification may be, but is not limited to, an email, a helpdesk ticket, and a short message service text message. In one embodiment, the notifications may be sent to support personnel associated with a specific subnet of the network. In another embodiment, the server 106 may display high-level metrics. High-level metrics may include, but are not limited to, a network-wide percentage of network devices that are not registered with the anti-virus control system, and a network-wide percentage of network devices that are not registered with the firewall system.

Using the example of the large organization, a first network scanner may discover the salesman's newly connected laptop by pinging all available network addresses on the network segment where the laptop is connected. A ping to the laptop's address may be returned indicating that a device exists at that network address. The first scanner may send the new network address to a database where it is inserted so that a second scanner and a third network scanner may learn about the new address.

Each network scanner 102a/102b/102c may also perform a separate function other than scanning the network 109. Separate functions may include, but are not limited to, scanning for compliance of virus software updates, operating system patches, and software patches. A scanned device that does not meet required levels of compliance may be automatically updated with software required to reach a proper level of compliance.

In some embodiments, scanners may have the separate function of determining accessibility. Once a new network address is located by a network scanner 102a/102b/102c, the network address may be probed for accessibility. A network scanner 102a/102b/102c may attempt to connect to the unknown device 104 using a series of known access commands including, but not limited to, known user names, and known passwords. If a network scanner 102a/102b/102c with a separate function of determining accessibility may access the unknown device 104, then the unknown device 104 may be scanned by one or more network scanners 102a/102b/102c with separate functions of determining the compliance level of the unknown device 104.

If the unknown device 104 is not accessible by a network scanner with a separate function of determining accessibility, then a notification may be sent to support personnel and data related to the unknown device may be inserted in the database 105. The notification may be, but is not limited to, an email, a helpdesk ticket, and a short message service text message. In one embodiment, the notifications may be sent to support personnel associated with a specific subnet of the network.

A server 106 may indicate that a new network address is not accessible. In some embodiments, support personal may access the database 105 and retrieve information about the unknown device. In other embodiments, the server 106 may trigger a message on a web page indicating that the new network address is not accessible. In this embodiment, support or help desk personal may be dispatched to remove the unknown device 104. Alternatively, support personnel may disable the network port associated with the unknown device 104. Dynamically scanning a network with scanners that perform more than one function and receiving a plurality of data feeds may provide faster response to unauthorized network access and devices out of compliance.

Using the example of the large organization, after the first network scanner discovers the salesman's newly connected laptop, a second network scanner may attempt to access the laptop using known usernames and passwords. In a first case, the salesman may be an outside salesman thus his laptop is a foreign laptop and the second network scanner may not be able to access his laptop. The second network scanner may notify a web server that this network address was inaccessible and a warning message may be posted on a web site notifying personal that an inaccessible device is on the network.

Still using the example of the large organization, in a second specific illustrative example, the salesman may be a company-employed salesman. Thus, after the first network scanner discovers the salesman's newly connected laptop the second network scanner may be able to access the laptop using known usernames and passwords. Accordingly, a third network scanner may now probe this laptop for software compliance to ensure that the salesman's laptop has the latest software patches loaded.

A network devices such as, but not limited to, a network server may contain a processor and a medium that stores instructions. The medium may, for example, contain a login script that when executed by a user device captures data associated with the user device. The data may include, but is not limited to, the network address of the user device, information regarding virus software updates, operating system patches, and software patches.

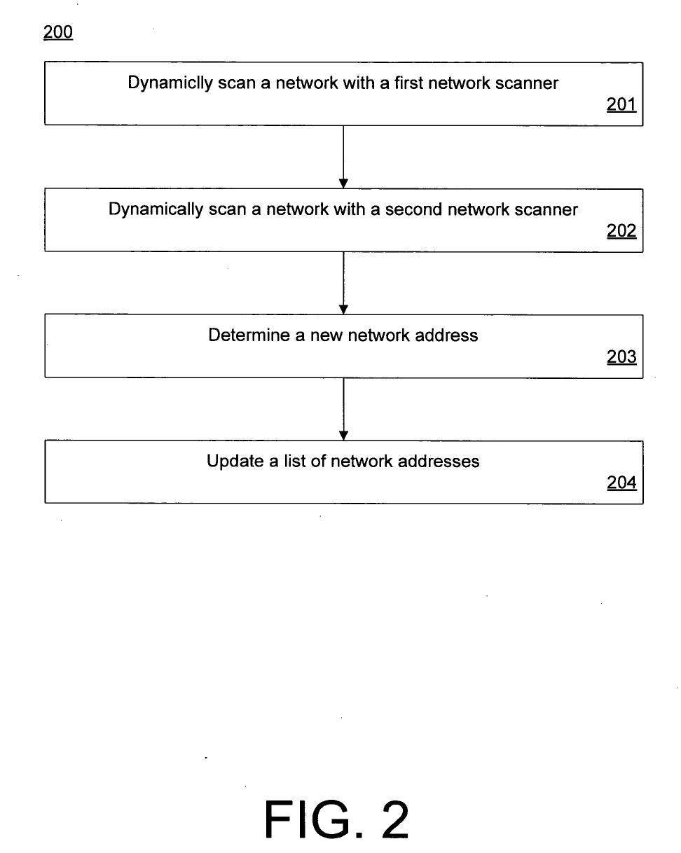

Referring now to FIG. 2, an embodiment of a method 200 is shown. At 201, a first network scanner dynamically scans a network. The first network scanner is connected to a segment of a network and may attempt to discover every network device connected to that segment. In some embodiments, the first network scanner may attempt to discover every network device on every segment of the network by dynamically scanning the network. The first network scanner may utilize an Internet control message protocol (“ICMP”) ping to discover each network device. However, in other embodiments the first network scanner may utilize any available protocol to discover new network addresses. The first network scanner may repeat dynamic scanning after a predetermined period of time or after all previously known network devices have been scanned. In some embodiments, the first network scanner may continuously dynamically scan the network.

The first network scanner may also perform a separate function other than just scanning the network. Separate functions may include, but are not limited to, scanning for compliance of virus software updates, operating system patches, and software patches. A scanned device that does not meet required levels of compliance may be automatically updated with software required to reach a proper level of compliance.

At 202, a second network scanner dynamically scans a network. The second network scanner is connected to a segment of a network and may attempt to discover every network device connected to that segment. In some embodiments, the second network scanner may attempt to discover every network device on every segment of the network by dynamically scanning the network. The second network scanner may utilize an Internet control message protocol (“ICMP”) ping to discover each network device. However, in other embodiments the second network scanner may utilize any available protocol to discover new network addresses. The second network scanner may repeat dynamic scanning after a predetermined period of time or after all previously known network devices have been scanned. In some embodiments, the second network scanner may continuously dynamically scan the network.

The second network scanner may also perform a separate function other than just scanning the network. Separate functions may include, but are not limited to, scanning for compliance of virus software updates, operating system patches, and software patches. A scanned device that does not meet required levels of compliance may be automatically updated with software required to reach a proper level of compliance.

At 203, the first scanner determines that there is a new active network address. In one embodiment, the first network scanner may dynamically scan to discover new network address. The first network scanner may ping all available network addresses on one or more network segments. A ping that is returned from an unknown address indicates that a device exists at that network address. The first scanner may send the new network address to a database where it is inserted so one or more other network scanners may learn of the new address. In some embodiments, an unknown device may be periodically connected and disconnected from a network. The unknown device may be any networkable device such as, but not limited to, a laptop computer, a desktop computer, a server, a wireless access point, a hub, and a switch. In one embodiment, the unknown device may belong to a salesman who has connected the unknown device to outside networks. In another embodiment, the unknown device may be attached to a network for illegal or illicit purposes such as for the unauthorized capture of data in which the connection is temporary and the device may be removed.

At 204, the new network address is updated into a database. The database may store network addresses provided and accessed by one or more network scanners. Each network scanner may access the database to determine what network addresses are known.

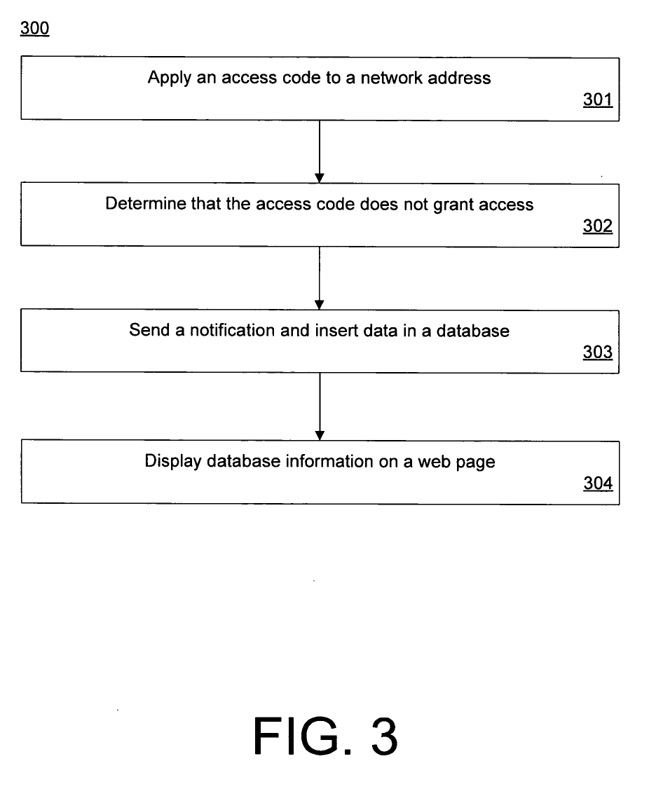

Referring now to FIG. 3, an embodiment of a method 300 is shown. At 301, an access code is applied to a newly discovered network address in an attempt to gain access to the network device. In some embodiments, one or more network scanners may have the separate function of determining accessibility. Once a network scanner discovers a new network address, the new network address may be probed for accessibility. A network scanner may attempt to connect to an unknown device associated with the new network address using a series of known access commands including, but not limited to, known user names, and known passwords.

At 302, a determination is made that the newly discovered network address is inaccessible using the known accesses commands. If an unknown device is inaccessible by a network scanner with a separate function of determining accessibility, then a notification may be sent to a web server indicating that a new network address is inaccessible.

At 303, a notification is sent to support personnel and data related to the notification is updated or inserted in a database. A server may send a notification to support personnel such as, but not limited to, a help desk and a desktop support group to inform the support personnel about the newly discovered network address. The notification may be, but is not limited to, an email, a helpdesk ticket, and a short message service text message. In some embodiments, the notifications are sent to support personnel associated with a specific subnet of the network.

At 304, a notification is displayed on a web page. A server may display information about the newly discovered network address. After viewing the message, support or help desk personal may be provided more information about the newly discovered network address. Dynamically scanning with scanners that perform more than one function may provide faster response to unauthorized network access and devices out of compliance.

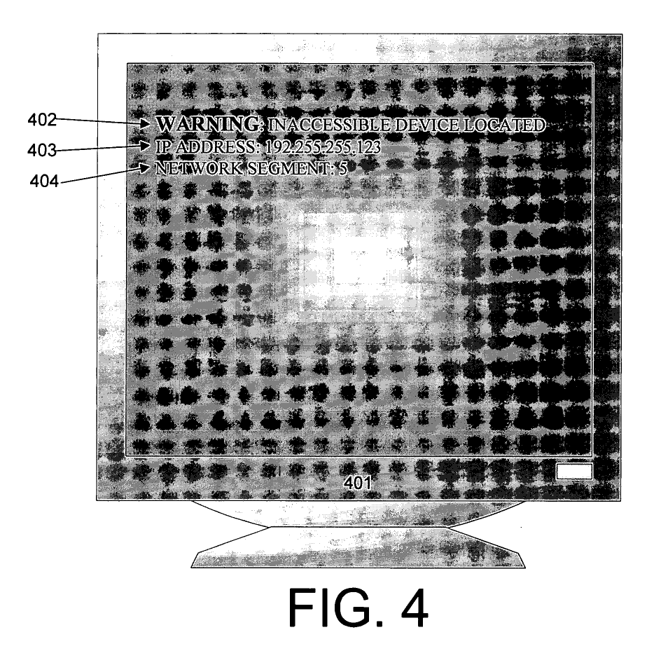

Referring now to FIG. 4, an embodiment of a display 401 is shown. The display may be any known display device. A display 401 may show a warning message 402 that an unknown device on a network is inaccessible. The warning message 402 may be followed by information that may help support personnel in locating the inaccessible device. Information that may help support personnel might include, but is not limited to, an IP address 403 of the unknown device and a network segment or subnet 404 where the inaccessible device is located.

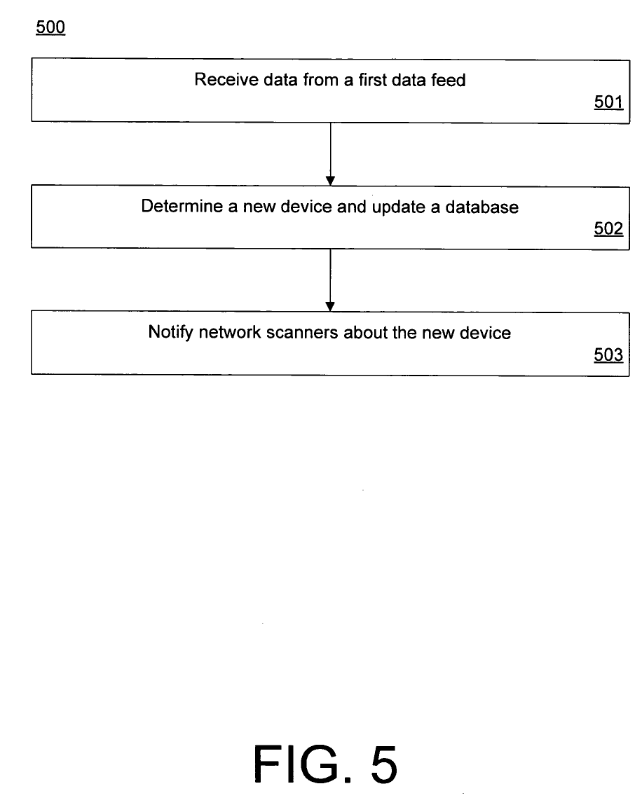

Referring now to FIG. 5, an embodiment of a method is shown. At 501, a database may receive data from a first data feed. Some examples of a data feed may be, but are not limited to, a login script, a central anti-virus control system, and a firewall system.

For example, a network user may log into the network invoking the execution of a login script. The commands in the login script may capture the user's network address and other compliance data. The data may include, but is not limited to, the network address of the network device, information regarding virus software updates, operating system patches, and other software patches. The login script may send the captured data to a database. The database may store network addresses provided and accessed by one or more network scanners and data feeds. Each network scanner and data feed may access the database to determine what network addresses are known.

At 502, a newly discovered device discovered by the first data feed that is not currently entered in a database may be inserted into the database. In one embodiment, the discovered network device may be determined to be new by combining data from the first data feeds and one or more network scanners.

At 503, data fields in the database that are not populated by the first data feed indicate which scanners or data feeds are needed to analyze the newly discovered device. A scanner required to populate specific database fields may be notified to gather information about the newly discovered device. In one embodiment, the network scanner may pull data about the newly discovered network device from a database. In another embodiment, support personnel may be notified that certain data feeds are not gathering information regarding the newly discovered devices. In yet another embodiment, a second data feed may pull data about the newly discovered device from a database.

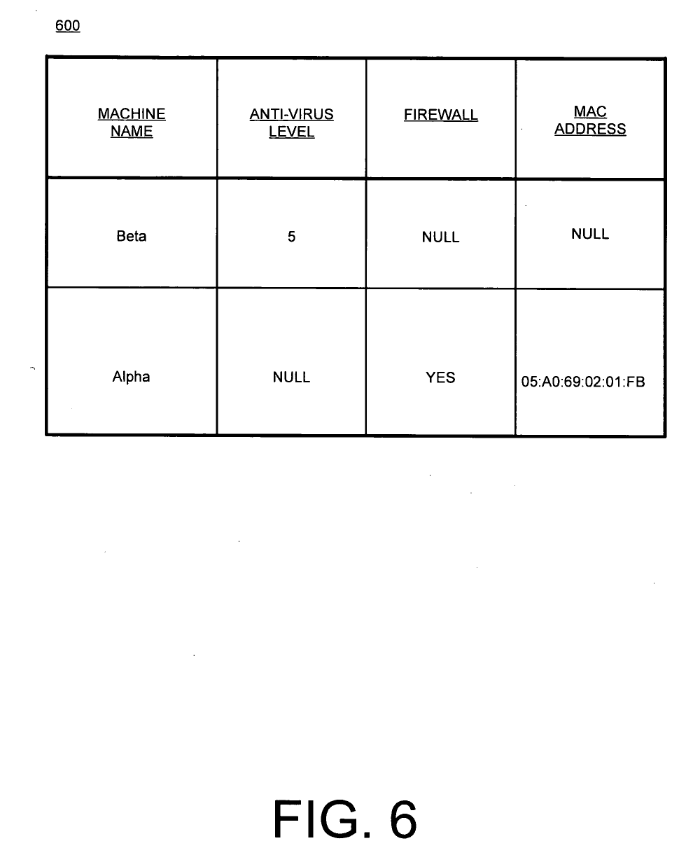

Referring now to FIG. 6, an embodiment of a database table 600 is shown. The database table 600 may have, but is not limited to, the following fields: MACHINE NAME, ANTI-VIRUS LEVEL, FIREWALL, and MAC ADDRESS. A machine name of Alpha may be an indication of a first device and a machine name of Beta may be an indication of a second device. As illustrated in FIG. 6, Alpha may have been discovered by both a firewall data feed and a network scanner. The network scanner may have inserted a MAC address into the database and the firewall system may have indicated that it currently communicates with Alpha. However, it may also be determined from the database that Alpha has not been discovered by the anti-virus software. By having an empty or null entry in the ANTI-VIRUS field a network scanner may be alerted or notified to discover the information needed to populate this field, support staff may be alerted or notified to add Alpha to the anti-virus system, or Alpha may automatically be added to a anti-virus system.

As illustrated in FIG. 6, Beta may have been discovered by a Anti-Virus system. It may be determined from the database that Beta has not been discovered by the firewall system or by a network scanner that gathers MAC addresses. By having empty or null entries in the FIREWALL and MAC ADDRESS fields a network scanner may be alerted to discover the information needed to populate these fields, support staff may be alerted or notified to add Beta to the firewall system, or Beta may be automatically added to the firewall system.

The foregoing disclosure has been described with reference to specific exemplary embodiments thereof. It will, however, be evident that various modifications and changes may be made thereto without departing from the broader spirit and scope set forth in the appended claims.

What is claimed is:

1. A system comprising:
a network;
a first network scanner; and
a second network scanner;
wherein the first network scanner, and the second network scanner dynamically scan the network,
wherein a network address discovered by the second network scanner and not discovered by the first network scanner is inserted into a database read by the first network scanner and the second network scanner.

2. The system of claim 1, wherein the first network scanner performs a first separate function, and the second network scanner performs a second separate function.

3. The system of claim 2, wherein the first network scanner, and the second network scanner dynamically scan the network in response to null values in data base fields.

4. The method of claim 1, further comprising:
a third network scanner, wherein the first network scanner, the second network scanner, and the third network dynamically scan the network,
wherein a network address discovered by the third network scanner and not discovered by the first network scanner or the second network scanner is inserted into a database read by the first network scanner and the second network scanner, and
wherein the first network scanner performs a first separate function, the second network scanner performs a second separate function, and the third network scanner performs a third separate function.

5. The system of claim 1, wherein the scanning of the network by the first network scanner, the second network scanner, and the third network scanner is automatically repeated after all previously known network devices have been scanned.

6. The system of claim 1, further comprising:
a web server, wherein a web page provided by the web server displays at least one of an indication that the new network address is not accessible and compliance metrics.

7. The system of claim 1, wherein the network comprises at least one of a MAN, a WAN, a LAN, and a VPN

8. The system of claim 1, further comprising:
a processor; and
a medium storing instructions adapted to be executed by the processor to perform a method, the method comprising:
inserting data from at least one data feed into the database;
determining a network address reported by the first network scanner or the second network scanner that is not associated with the at least one data feed; and
sending a notification related to the network address reported by the first network scanner.

9. The system of claim 8, wherein the determining comprises:
combining data from the at least one data feed, the first network scanner, and the second network scanner.

10. The system of claim 9, further comprising instructions adapted to be executed by the processor to perform a method, the method comprising:
displaying a network-wide metric based on the combined data.

11. The system of claim 8, further comprising instructions to:
execute a login script; and
send a network address to the database.

12. The system of claim 1, wherein the dynamically scanning is performed by using an Internet Control Message Protocol ping.

13. A method comprising:
dynamically scanning a network with a first network scanner;
dynamically scanning the network with a second network scanner;
determining a new network address, wherein the new network address is discovered by the first network scanner and not discovered by the second network scanner; and
updating the second scanner with the new address.

14. The method of claim 13, wherein the first network scanner performs a first separate function, and wherein the second network scanner performs a second separate function.

15. The system of claim 14, wherein the first network scanner, and the second network scanner dynamically scan the network in response to null values in data base fields.

16. The method of claim 13, further comprising:
determining that the new network address is not accessible; and
displaying a notification that the new network address is not accessible on a web page.

17. The method of claim 13, wherein the determining comprises:
applying one or more access codes to a device located at the new network address; and
determining that the one or more access codes do not grant access to the device,
wherein the one or more access codes are applied by at least one of the first scanner, and the second scanner.

18. The method of claim 13, further comprising:
dynamically scanning a network with a third network scanner; and
determining a second new network address, wherein the second new network address is discovered by the third network scanner and not discovered by either the first scanner or the second scanner;
updating the first scanner with the second address; and
updating the second scanner with the second address,
wherein the third network scanner performs a third separate function.

19. The method of claim 13, wherein the method is automatically repeated after all previously known devices have been scanned.

20. The method of claim 13, wherein the new network address is added to a database.

21. The method of claim 13, further comprising:
inserting data from a data feeds into a database;
determining a network address reported by the first network scanner or the second network scanner that are not associated with the data feed; and sending a notification related to the network address reported by the first network scanner.

22. The method of claim 21, wherein the determining comprises:
combining data from the at least one data feed, the first network scanner, and the second network scanner.

23. The method of claim 22, further comprising:
displaying a network-wide metric based on the combined data.

24. The method of claim 21, further comprising:
executing a login script; and
sending a network address to the database as a result of the login script.

25. The method of claim 13, wherein the network comprises at least one of a WAN, a LAN, and a VPN.

26. The method of claim 13, wherein the dynamically scanning is performed by using an Internet Control Message Protocol ping.
